(19) United States
(12) Patent Application Publication
(10) Pub. No.: US 2014/0131537 A1
(43) Pub. Date: May 15, 2014

(54) SUPPORTING BRACKET FOR DISPLAY

(71) Applicants: HONG FU JIN PRECISION INDUSTRY (ShenZhen) CO., LTD., (US); HON HAI PRECISION INDUSTRY CO., LTD., New Taipei (TW)

(72) Inventor: MING-LIANG ZHANG, Shenzhen (CN)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 13/686,770

(22) Filed: Nov. 27, 2012

(30) Foreign Application Priority Data
Nov. 12, 2012 (CN) 201210449852X

(51) Int. Cl. F16M 13/00

(52) U.S. Cl. CPC F16M 13/005
USPC 248/295.11

(57) ABSTRACT

A supporting bracket for fixing one or two displays includes a base, an extension bar, a cantilever bar, and a fixing bar mounted to the base. A number of fixing pins extend from each of opposite sides of the fixing bar. The extension bar and the cantilever bar each define a number of through holes to be fitted around the corresponding fixing pins. A fixing member is formed at each of a side of the extension bar, a side of the cantilever bar, an end of the fixing bar, and an end of the extension bar, to be fixed to a display.

### BACKGROUND

1. Technical Field

The present disclosure relates to a bracket for supporting one or more displays.

2. Description of Related Art

A screen of a display is the main interface for people to get information from a computer. However, most of the displays cannot be raised, which is undesirable.

Furthermore, a small screen cannot display as many windows as desired. A display with a wide screen may be provided to replace the display with a small screen. However, the display with a wide screen is more expensive. Additionally, discarding the displays with small screens is wasteful, especially for a corporation with a large number of such displays.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is an exploded, isometric view of an exemplary embodiment of a supporting bracket, together with one display.

FIGS. 2 to 4 are assembled, isometric view of FIG. 1, but showing different use states.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean at least one.

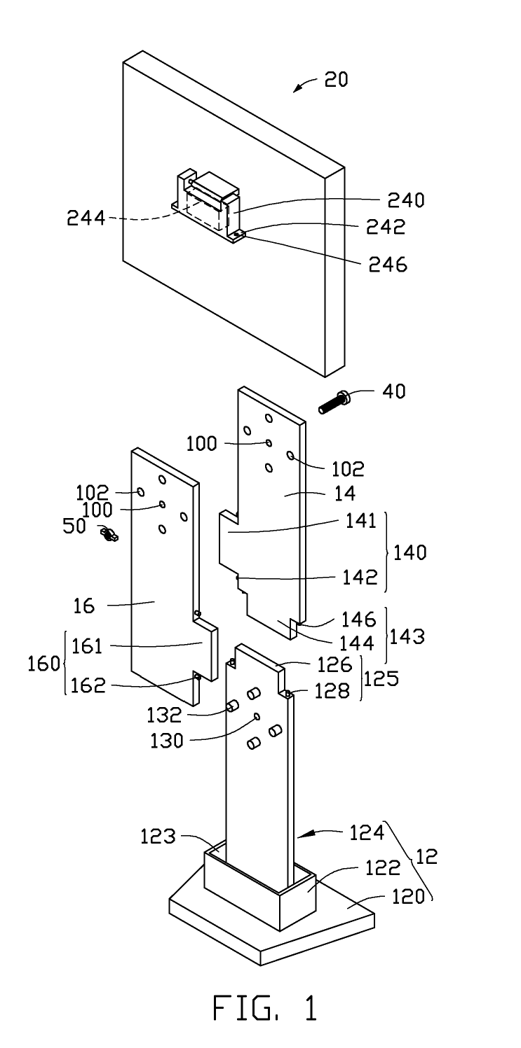

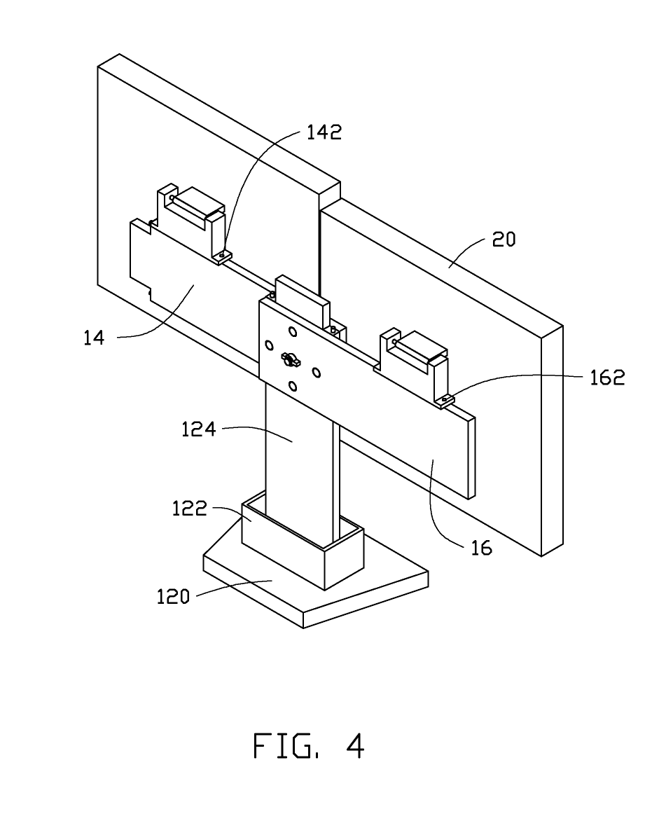

FIGS. 1 and 4 illustrate an exemplary embodiment of a supporting bracket. The supporting bracket may be provided for holding a display 20 in different heights, or be provided for holding two displays 20.

The display 20 includes a receiving member 240 mounted to a rear side of the display 20. Two positioning portions 242 extend from opposite ends of a bottom of the receiving member 240. The receiving member 240 defines a receiving space 244 extending through the bottom of the receiving member 240. Each positioning portion 242 defines a vertical positioning hole 246.

The supporting bracket includes a main body 12, an extension bar 14, and a cantilever 16.

The main body 12 includes a base 120, a holding portion 122 mounted on the base 120 and defining a receiving room 123 in a top surface, and a fixing bar 124 having a bottom end received in the receiving room 123 and perpendicularly connected to the base 120.

The fixing bar 124 includes a fixing member 125 to be mounted to one of the displays 20. The fixing member 125 includes a block 126 extending up from a middle of a top end of the fixing bar 24 and two pins 128 protruding up from the top end of the fixing bar 24 at opposite sides of the block 126. The fixing bar 124 defines a fixing hole 130 extending through opposite side surfaces of the fixing bar 124 below the block 126. Four fixing pins 132 perpendicularly extend out from each of the opposite side surfaces of the fixing bar 124 around the fixing hole 130.

The extension bar 14 includes two fixing members 140 and 143 each are capable of being fixed to one of the displays 20. The fixing member 140 includes a block 141 protruding leftward from a lower portion of a left side of the extension bar 14, and two pins 142 protruding leftward from the left side of the extension bar 14 and respectively above and below the block 141. The fixing member 143 includes a block 144 protruding down from a bottom end of the extension bar 14, and two pins 146 protruding down from the bottom end of the extension bar 14 at opposite sides of the block 144. The extension bar 14 defines a fixing hole 100 adjacent to a top end of the extension bar 14 opposite to the block 144 and four through holes 102 around the fixing hole 100.

The cantilever 16 includes a fixing member 160 which is capable of being fixed to one of the displays 20. The fixing member 160 includes a block 161 protruding rightward from a lower portion of a right side of the cantilever 16, and two pins 162 protruding rightward from the right side of the cantilever 16 and respectively above and below the block 161. The cantilever 16 defines a fixing hole 100 adjacent to a top end of the cantilever 16 opposite to the block 161 and four through holes 102 around the fixing hole 100.

Heights of the fixing bar 124, the extension bar 14, and the cantilever 16 are the same.

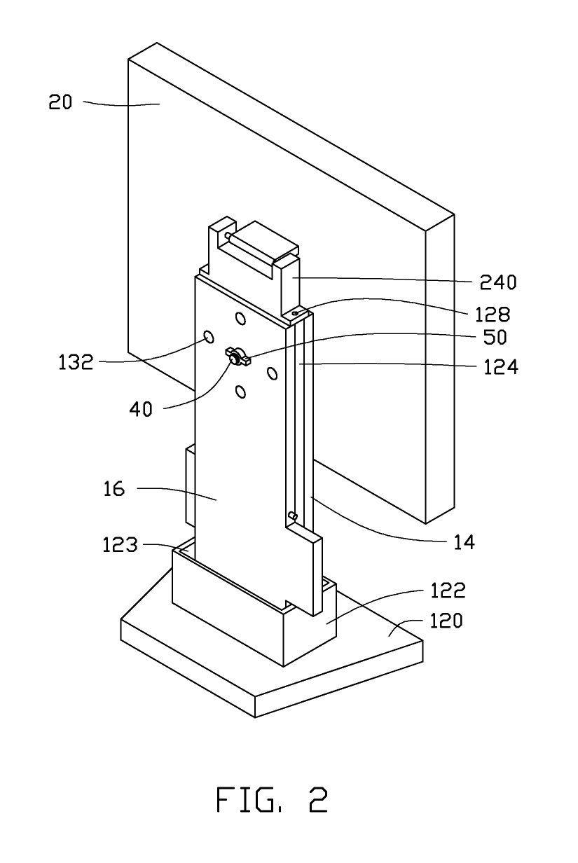

FIG. 2 shows that in assembling a display 20 in a lower position, the block 126 is inserted into the receiving space 244, and the pins 128 are inserted into the corresponding positioning holes 246, to fix the display 20 to the top end of the fixing bar 124.

At this time, the bottom ends of the extension bar 14 and the cantilever 16 are received in the receiving room 123 at opposite sides of the fixing bar 124. The fixing pins 132 are inserted into the corresponding through holes 102 of the extension bar 14 and the cantilever 16. A fastener, such as a screw 40, extends through the fixing hole 100 of the extension bar 14, the fixing hole 132 of the fixing bar 124, and the fixing hole 100 of the cantilever 16, to be engaged in a nut 50, thereby fixing the extension bar 14 and the cantilever 16 to the opposite side surfaces of the fixing bar 124. The top ends of the extension bar 14 and the cantilever 16 support the receiving member 240 and the positioning portions 242 at front and rear sides of the receiving space 244.

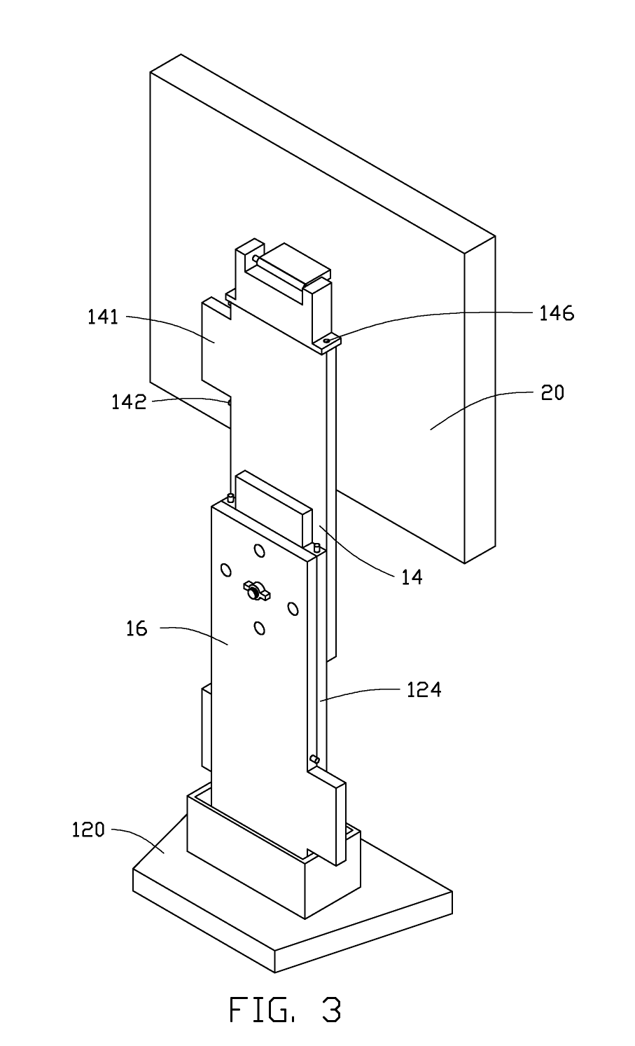

FIG. 3 shows that when rising the display 20, the screw 40 is released from the nut 50. The extension bar 14 is disengaged from the receiving room 123 and the fixing bar 124. The extension bar is inverted, the block 144 is turned to be at a top end of the extension bar 14. The fixing pins 132 facing the extension bar 14 are inserted into the corresponding through holes 102 of the extension bar 14. The screw 40 extends through the fixing hole 100 of the extension bar 14, the fixing hole 132 of the fixing bar 124, and the fixing hole 100 of the cantilever 16, to be engaged in the nut 50, thereby fixing the extension bar 14 to the fixing bar 124. The block 144 is inserted into the receiving space 244, and the pins 146 are inserted into the corresponding positioning holes 246, to fix the display 20 on a top end of the extension bar 14 away from the fixing bar 124.

FIG. 4 shows that in assembling of two displays 20, the screw 40 is disengaged from the nut 50. The extension bar 14 and the cantilever 16 are disengaged from the receiving room 123 and the fixing bar 124. The extension bar 14 and the cantilever 16 are turned about 90 degrees. The fixing pins 132 are inserted into the corresponding through holes 102 of the extension bar 14 and the cantilever 16. The extension bar 14 and the cantilever 16 are extended in opposite directions, which are perpendicular to the fixing bar 124. The blocks 141 and 161 are arranged to be extended upward. The screw 40 extends through the fixing hole 100 of the extension bar 14, the fixing hole 132 of the fixing bar 124, and the fixing hole 100 of the cantilever 16, to be engaged in the nut 50, thereby fixing the extension bar 14 and the cantilever 16 to the fixing bar 124. The blocks 141 and 161 are engaged in the receiving spaces 244 of the corresponding displays 20, and the pins 142 and 162 are inserted into the corresponding positioning holes 246, thereby fixing the two displays 20 side by side.

In another embodiment, the cantilever 16 can be replaced by another extension bar 14 in response to fixing two displays 20.

It is believed that the present embodiments and their advantages will be understood from the foregoing description, and various changes may be made thereto without departing from the spirit and scope of the description or sacrificing all of their material advantages, the examples hereinbefore described merely being exemplary embodiments.

What is claimed is:

1. A supporting bracket for mounting displays each comprising a receiving member and two positioning portions, the supporting bracket comprising:
a base;
a fixing bar mounted on the base; a plurality of fixing pins protruding out from each of two opposite side surfaces of the fixing bar;
an extension bar defining a plurality of through holes to fit about corresponding ones of the fixing pins of one of the two opposite side surfaces of the fixing bar; and
a cantilever defining a plurality of through holes to fit about corresponding ones of the fixing pins of the other one of the two opposite side surfaces of the fixing bar;
wherein, a fixing member extends from each of a side of the extension bar, an end of the extension bar, a side of the cantilever, and an end of the fixing member, and is to be engaged with the receiving member and the two positioning portions of a first one of the displays.

2. The supporting bracket of claim 1, wherein each fixing member comprises a block to be engaged in a receiving space defined in the receiving member of the first display.

3. The supporting bracket of claim 2, wherein each fixing member further comprises two pins at opposite sides of the block to be engaged in the corresponding positioning portions of the first display in response to the block engaging in the receiving space of the display.

4. The supporting bracket of claim 1, wherein the through holes of the extension bar are defined adjacent to a first end of the extension bar, the fixing members of the extension bar are extended from a second end of the extension bar opposite to the first end and a side of the extension portion adjacent to the second end.

5. The supporting bracket of claim 4, wherein the through holes of the cantilever are defined adjacent to a first end of the cantilever, the fixing members of the cantilever is extended from a side of the cantilever adjacent to a second end of the cantilever opposite to the first end.

6. The supporting bracket of claim 5, wherein the extension bar, the cantilever, and the fixing bar each define a fixing hole, the extension bar and the cantilever are fixed to the opposite side surfaces of the fixing bar by a fastener extending through the fixing holes and then engaging in a nut.

7. The supporting bracket of claim 6, wherein the through holes of the extension bar and the cantilever are defined around the corresponding fixing holes; the fixing pins are positioned around the fixing hole of the fixing bar.

8. The supporting bracket of claim 1, wherein when mounting more than one of the displays, the extension bar and the cantilever are perpendicularly fixed to the fixing bar via the pins and the through holes, extend away from each other, the two fixing members of the side of the extension bar and the side of the cantilever are engaged with the first display and a second one of the displays, respectively.

9. The supporting bracket of claim 1, wherein when mounting the first display in a raised position, the extension bar are fixed to the fixing bar in an extension direction of the fixing bar, and the fixing member of at the end of the extension bar is engaged with the first display.
